(19) United States
(12) Patent Application Publication
(10) Pub. No.: US 2022/0180571 A1
(43) Pub. Date: Jun. 9, 2022

(54) INFORMATION PROCESSING DEVICE, INFORMATION PROCESSING METHOD, AND PROGRAM

(71) Applicant: SONY GROUP CORPORATION, Tokyo (JP)

(72) Inventors: Honoka OZAKI, Tokyo (JP); Yuri KUSAKABE, Tokyo (JP); Kentaro IDA, Tokyo (JP)

(73) Assignee: SONY GROUP CORPORATION, Tokyo (JP)

(21) Appl. No.: 17/442,356

(22) PCT Filed: Apr. 2, 2020
(86) PCT No.: PCT/JP2020/015248

§ 371 Date: Sep. 23, 2021

(30) Foreign Application Priority Data
Apr. 9, 2019 (JP) 2019-073994

(51) Int. Cl. G06T 11/00; G06F 3/01; G09G 3/00; G06T 7/73

(52) U.S. Cl. CPC G06T 11/00; G06F 3/012; G09G 3/002; G06F 3/016; G06T 2210/22; G09G 2354/00; G06T 2207/30201; G09G 2340/14; G06T 7/73

(57) ABSTRACT

An information processing device includes a control unit that controls to output, within a peripheral field-of-view region of a user, a first-mode notification for guiding the user to a notification target disposed in a real space on the basis of determination information on a field-of-view range of the user based on a captured image.

### FIELD

The present disclosure relates to an information processing device, an information processing method, and a program.

### BACKGROUND

In recent years, a drive-type projector equipped with a pan/tilt drive mechanism has been developed for a projector projecting an image on a wall or a screen. An image can be projected at any place by driving the projector.

In addition, Patent Literature 1 below discloses a technology for generating an image giving a virtual shadow effect to a real space when content is to be displayed by a device such as a projector or a touch panel display, thereby giving a user a sense of reality of the displayed content.

### CITATION LIST

### Patent Literature

Patent Literature 1: JP 2016-162142 A

### SUMMARY

### Technical Problem

Here, in a case where a certain notification is given to a user using a device such as a projector or a touch panel display, it is necessary to attract the user's attention, and thus, the notification is given while interrupting the user's work.

However, in a case where such a notification given while interrupting the user's work is information with a low degree of urgency or information with a low degree of importance for the user, it is concerned that the user may feel annoyed and stress may be accumulated.

### Solution to Problem

According to the present disclosure, an information processing device is provided that includes: a control unit that controls to output, within a peripheral field-of-view region of a user, a first-mode notification for guiding the user to a notification target disposed in a real space on the basis of determination information on a field-of-view range of the user based on a captured image.

According to the present disclosure, an information processing method is provided that includes: controlling, by a processor, to output, within a peripheral field-of-view region of a user, a first-mode notification for guiding the user to a notification target disposed in a real space on the basis of determination information on a field-of-view range of the user based on a captured image.

According to the present disclosure, a program is provided that causes a computer to function as: a control unit that controls to output, within a peripheral field-of-view region of a user, a first-mode notification for guiding the user to a notification target disposed in a real space on the basis of determination information on a field-of-view range of the user based on a captured image.

### BRIEF DESCRIPTION OF DRAWINGS

FIG. 1 is a diagram for explaining an outline of an information processing system according to an embodiment of the present disclosure.

FIG. 2 is a block diagram illustrating an example of a functional configuration of each device in the information processing system according to the embodiment of the present disclosure.

FIG. 3 is a diagram for explaining a field-of-view range and a work region according to the embodiment of the present disclosure.

FIG. 4 is a flowchart illustrating an example of a flow of operation processing according to a first example of the embodiment of the present disclosure.

FIG. 5 is a flowchart illustrating an example of a flow of operation processing according to a second example of the embodiment of the present disclosure.

FIG. 6 is a flowchart illustrating an example of a flow of operation processing according to a third example of the embodiment of the present disclosure.

FIG. 7 is a diagram for explaining a combination of modalities according to a situation for use in a first-mode notification and a second-mode notification according to the embodiment of the present disclosure.

### DESCRIPTION OF EMBODIMENTS

Hereinafter, a preferred embodiment of the present disclosure will be described in detail with reference to the accompanying drawings. Note that, in the present specification and the drawings, components having substantially the same functional configurations will be denoted by the same reference numerals, and description thereof will not be repeated.

Further, the description will be given in the following order.

1. Overview of Information Processing System According to Embodiment of Present Disclosure

2. Example of Configuration

3. Examples

3-1. First Example

3-2. Second Example

3-3. Third Example

4. Supplement

5. Conclusion

### 1. OUTLINE OF INFORMATION PROCESSING SYSTEM ACCORDING TO EMBODIMENT OF PRESENT DISCLOSURE

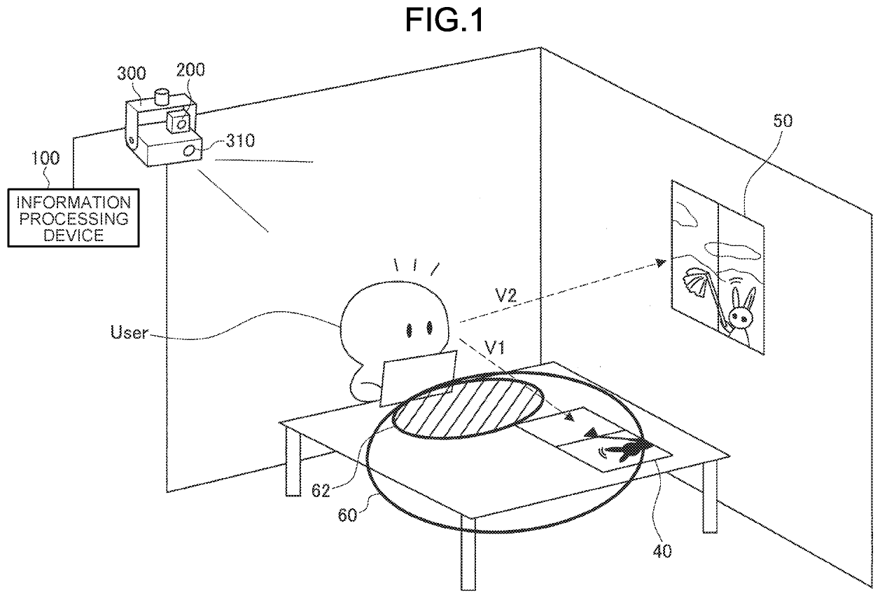

FIG. 1 is a diagram for explaining an outline of an information processing system according to an embodiment of the present disclosure. As illustrated in FIG. 1, an information processing system 1 according to the present embodiment includes an output device 300 outputting information to a real space, a sensor device 200 sensing the information on the real space, and an information processing device 100 controlling the output device 300 to output notification information to a user on the basis of the information sensed by the sensor device 200.

In an example illustrated in FIG. 1, a drive projector capable of projecting an image onto any location in a space is assumed as an example of the output device 300. The drive projector may have a drive mechanism mounted to change a projection direction, such as a pan/tilt drive mechanism, or may have a mechanism mounted to move the drive projector itself leftward, rightward, upward, downward, or the like.

Furthermore, in the example illustrated in FIG. 1, the sensor device 200 is provided in the drive projector. For example, in a case where the sensor device 200 is a camera, an image can be captured in the same direction as the projection direction. Note that the sensor device 200 is not limited to being provided in the drive projector, and may be provided at any location in the space. Furthermore, there may be a plurality of output devices 300 and sensor devices 200, and they may be provided in a plurality of types.

(Background)

As described above, in general, in a case where a certain notification is given to the user using a device such as a projector, it is necessary to attract the user's attention, and thus, the notification is given while interrupting the user's work. However, in a case where such a notification given while interrupting the user's work is information with a low degree of urgency or information with a low degree of importance for the user, it is concerned that the user may feel annoyed and stress may be accumulated.

Therefore, in view of such circumstances, in the present disclosure, as a first stage of notification, a first-mode notification for guidance to a notification target disposed in the real space is given in a peripheral field-of-view range of the user, such that the user can be casually notified at least that there is a certain notification without disturbing the user's work.

In the present specification, the “peripheral field of view” is a region excluding a central field-of-view region in a field-of-view range of the user. In general, a human has a field of view of about 120 degrees, and characteristics of the field of view can be classified into a “central view”, an “effective field of view”, and a “peripheral field of view”, for example, according an object identification level. That is, the “central view” is in a range in which a shape or a color of an object, a character, or the like can be clearly identified, and corresponds to a range of about 1 degree to 2 degrees from a focused gaze point. The central-view range includes a range commonly referred to as “discriminative field of view” and “word identification limit”. In addition, the “effective field of view” is in a range in which a shape of an object can be almost clearly recognized around the central view, and corresponds to, for example, a range of about 4 degrees to 20 degrees from the gaze point. In the present embodiment, the “central view” and “effective field-of-view” range is referred to as “central field-of-view region”.

In addition, the “peripheral field of view” is in a range other than the central view and the effective field of view (that is, the central field-of-view region), and is in a range in which a character, a shape or a color of an object, or the like cannot be clearly identified, but movement can be noticed, such as animation displayed as an image.

In a case where the user is working, since the object is visually recognized mainly in the central field-of-view region, even if a certain notification is given in the peripheral field of view, the user's work is not definitely interrupted. When the user suddenly turns his/her eyes or senses a notification with the tail of his/her eye, the user's line of sight is turned toward the first-mode notification. Thus, it is possible to avoid forcedly interrupting the user's work to recognize the first-mode notification in the central field-of-view region, which causes stress.

For example, as illustrated in FIG. 1, in a case where the user is working on a PC or the like, when a notification for urging the user to perform cleaning is given, the information processing device 100 outputs a second-mode notification 50 (an example of a notification target) for urging the user to perform cleaning to a location that does not fall within the field-of-view range of the user, such as a wall, while outputting a first-mode notification 40 for guiding the user to the second-mode notification 50 to a peripheral field-of-view region 60 excluding a central field-of-view region 62 in the field-of-view range of the user.

For the first-mode notification 40, a more natural expression is preferable. For example, when the notification target is a window (which may be a real object or a virtual object (such as a projection image)), it is preferable for the notification to use an expression reproducing a natural phenomenon, such as a shadow thereof (an image expressing sunlight coming inside from the window). Accordingly, it is possible to avoid forcibly attracting the user's attention or disturbing the user's concentration state because of an unnatural expression (that is, it is difficult to forcibly shift the user' gaze point).

In the example illustrated in FIG. 1, an image showing that a character is moving with a cleaning tool outside the window is projected onto the wall as the second-mode notification 50, and an image showing a shadow of the window is projected onto a table as the first-mode notification 40. The second-mode notification 50 is output to a position away from the first-mode notification 40.

Since the first-mode notification 40 is projected onto the peripheral field-of-view region 60 of the user, there is an advantageous effect in that the user's work is not forcibly disturbed. The user senses, with the tail of the eye, the shadow of the character that is moving or the light that has come inside, and in a case where the user is concerned thereabout, the user's line of sight V1 is turned toward the first-mode notification 40. When the first-mode notification 40 is visually recognized, it can be seen that the character is trying to tell something. Therefore, in a case where the user wants to know notification contents, the user's line of sight V2 is further turned toward the origin of the shadow, that is, the second-mode notification 50. The second-mode notification 50 is output to a position away from the first-mode notification 40. However, by using a human “ability to infer a cause from a result”, the user's line of sight can be guided toward the second-mode notification 50 without directly and definitely indicating, in the first-mode notification 40, the location where the second-mode notification 50 is output. The human can infer and find a cause of an environmental change. For example, the position of the window can be inferred when the shadow of the window is cast, it can be recognized where wind or smell originates from based on a direction in which the wind or the smell is felt, and it can be recognized where sound originates from based on a direction in which the sound is made.

The user visually recognizes the second-mode notification 50, and it can be seen, for example, from the character with the cleaning tool that cleaning is urged. Note that, for example, in a case where the character is a mother's avatar, it can be seen that cleaning is urged by the mother.

On the other hand, in a case where the user has noticed the first-mode notification 40 but wants to concentrate on the work, the user can continue the work without looking at the second-mode notification 50.

In this way, by expressing the notification in a stepwise manner, it is possible to give the notification without disturbing the user's work.

Note that the notification target is not limited to the projection image (second-mode notification 50) showing notification contents as illustrated in FIG. 1, and may be a real object. The presence of the real object can be recalled or the direction of the real object can be implicitly indicated by the first-mode notification 40, thereby reminding the user of a task related to the real object. For example, when it is detected that a key of a door is not locked, the user is reminded of the presence of the door, thereby recalling forgetting that the key should be locked. In this case, as the first-mode notification 40, a picture of the key is displayed in the peripheral field of view, or a sound of the key being unlocked is presented. In addition, in a case where a washing machine finishes washing but the washing machine is left neglected for a predetermined time, the user is reminded of the presence of the washing machine. In this case, a picture of the washing machine or laundry is displayed in the peripheral field of view in order to recall a task such as taking out laundry from the washing machine to dry the laundry.

Furthermore, the first-mode notification 40 is not limited to the visual notification (displaying a projection image or the like), and may be at least one of an auditory notification (outputting a voice), a tactile notification (outputting vibration, wind, or the like), and an olfactory notification (outputting a smell), or a combination thereof.

The information processing system according to the embodiment of the present disclosure has been described above. Next, a specific configuration of each device included in the information processing system according to the present embodiment will be described with reference to the drawings.

### 2. EXAMPLE OF CONFIGURATION

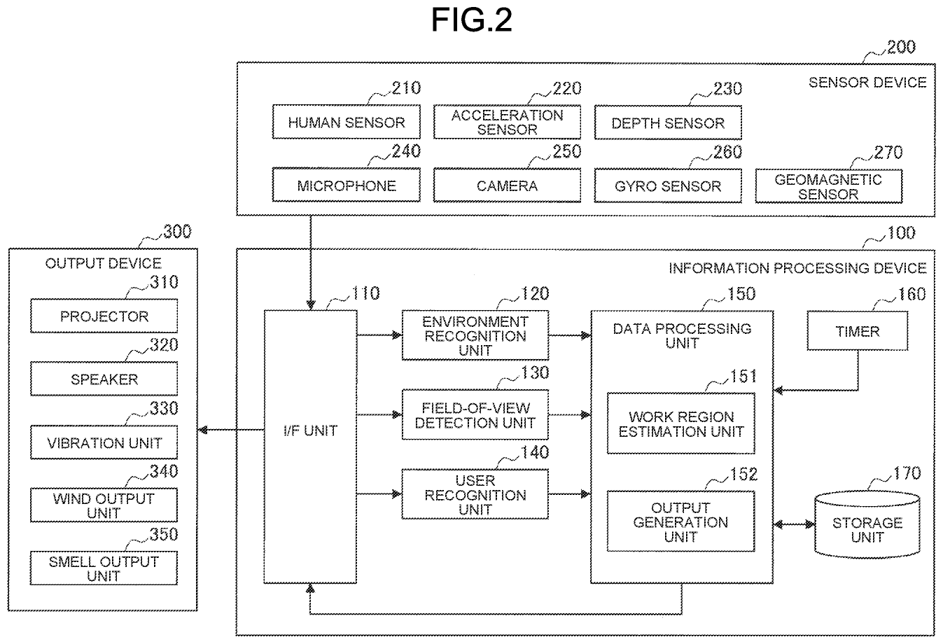

FIG. 2 is a block diagram illustrating an example of a functional configuration of each device in the information processing system according to the embodiment of the present disclosure. As illustrated in FIG. 2, the information processing system according to the present embodiment includes an information processing device 100, a sensor device 200, and an output device 300.

<2-1. Example of Configuration of Information Processing Device 100>

The information processing device 100 includes an interface (I/F) unit 110, an environment recognition unit 120, a field-of view detection unit 130, a user recognition unit 140, a data processing unit 150, a timer 160, and a storage unit 170.

(I/F Unit 110)

The I/F unit 110 is a connector for connecting the information processing device 100 to another device. The I/F unit 110 is implemented by, for example, a universal serial bus (USB) connector or the like, and inputs and outputs information to and from each component of the sensor device 200 and the output device 300. In addition, the I/F unit 110 is connected to the sensor device 200 and the output device 300, for example, by means of a wireless/wired local area network (LAN), digital living network alliance (DLNA) (registered trademark), Wi-Fi (registered trademark), Bluetooth (registered trademark), other exclusive lines, or the like. In addition, the I/F unit 110 may be connected to another device via the Internet or a home network.

For example, the I/F unit 110 receives data sensed by each sensor from the sensor device 200. In addition, the I/F unit 110 transmits a drive control signal and an output signal such as an image or a voice to the output device 300.

(Environment Recognition Unit 120)

The environment recognition unit 120 estimates an environment around a user. For example, the environment recognition unit 120 recognizes a three-dimensional space and calculates a projection surface. The environment recognition unit 120 can recognize a three-dimensional shape and an environment (brightness or the like) of a projection environment, a three-dimensional shape and a three-dimensional position of a real object existing in the projection environment, a projectable region (a projection surface such as a planar region having a predetermined size), a three-dimensional position of a user, and the like, on the basis of sensing data detected by various kinds of sensors (a captured image acquired by a camera (a visible light image or an infrared image), depth information acquired by a depth sensor, voice information acquired by a microphone, distance information acquired by a human sensor, temperature information acquired by a temperature sensor, illuminance information acquired by an illuminance sensor, and the like). A result of recognizing the three-dimensional space, a result of calculating the projection surface, information on the position of the user, and the like are output to the data processing unit 150.

(Field-of-View Detection Unit 130)

The field-of-view detection unit 130 determines a field-of-view range of the user on the basis of a captured image. For example, the field-of-view detection unit 130 captures the user with the camera according to the three-dimensional position of the user obtained by recognizing the three-dimensional space, detects a position, a face orientation, a posture, and the like of the user from the captured image, and estimates a line-of-sight direction. In addition, the field-of-view detection unit 130 may estimate a position at which the line-of-sight direction is orthogonal to a real object (corresponding to a work object) existing in the line-of-sight direction as a gaze point. Furthermore, the field-of-view detection unit 130 may determine a field-of-view range from the face orientation, the posture, and the like of the user to determine a range within about a predetermined angle from the estimated gaze point as a central field-of-view region or a peripheral field-of-view region. A result of determining the field-of-view range of the user is output to the data processing unit 150.

(User Recognition Unit 140)

The user recognition unit 140 recognizes the user from the sensing data. For example, the user recognition unit 140 identifies the user by recognizing a user's face on the basis of the captured image obtained by capturing the user's face. A result of identifying the user is output to the data processing unit 150.

(Data Processing Unit 150)

The data processing unit 150 processes the data output from the environment recognition unit 120, the field-of-view detection unit 130, and the user recognition unit 140 to control a notification. Specifically, the data processing unit 150 functions as a work region estimation unit 151 and an output generation unit 152.

The work region estimation unit 151 estimates a work region within the field-of-view range of the user on the basis of a field-of-view direction of the user detected by the field-of-view detection unit 130, a situation around the user (a real object existing around the user or the like), and a distance between the user and the work object recognized by the environment recognition unit 120, and the like. For example, the work region estimation unit 151 estimates, as the work region, a screen of a PC or a smartphone that the user is operating in a line-of-sight direction of the user, a book that the user is looking at when reading the book, a keyboard region when the user is looking at and operating the keyboard, or a hand-reachable periphery when the user is doing dishwashing, cooking, tidying up laundry, or the like.

Note that the estimation of the work region by the work region estimation unit 151 and the detection of the field of view by the field-of-view detection unit 130 described above are not limited to the method based on the data sensed by the camera or the like provided in the environment, and a wearable device worn by the user can be used for more accurate detection. For example, there is also a method in which user's pupils of eyes are detected with a camera inside a glasses-type wearable device to estimate a line of sight, and this is combined with a captured image obtained by an outward camera of the wearable device to estimate a field-of-view range and a work region. In addition, there is also a method in which a field-of-view range and a work region are estimated by using an eye tracker provided on the work object or the like although a position of a user is fixed.

Subsequently, the output generation unit 152 generates information for notification to the user. The notification to the user can be assumed to be, as an example, a notification of a task set by the user in advance with a timer (dishwashing or the like), operation in cooperation with a scheduler (a time to go out or the like), a recommendation according to an environment or a situation (a suggestion that futons be dried because weather is good or the like), a notice (arrival of mail, news, or the like), a message (“tidy up the room”, “it's time for dinner”, or the like from a parent), or the like. As an example, the output generation unit 152 generates a second-mode notification showing notification contents and a first-mode notification for guidance to the second-mode notification. The first-mode notification implements notification with which a human's target of attention is difficult to forcibly change by adopting an expression suitable for a behavior based on the laws of physics and a space thereof without causing an uncomfortable feeling. For example, as described with reference to FIG. 1, a virtual window can be selected for the second-mode notification and an expression using a natural phenomenon, i.e. a shadow of the window, can be adopted for the first-mode notification, thereby implementing an expression suitable for the space, without causing an uncomfortable feeling, while naturally corresponding to the second-mode notification. The second-mode notification shows specific notification contents. For example, the second-mode notification may be shown as a text icon or the like as in the conventional method. Alternatively, a virtual window or door displayed on a wall, a virtual cloud displayed on a ceiling, a character displayed on the wall or the ceiling, or the like may be selected for the second-mode notification, and the first-mode notification may be in the form of a virtual shadow or virtual coming-inside light thereof, so that the second-mode notification can naturally correspond to the first-mode notification.

Here, Table 1 below provides an example of a natural phenomenon that can be used for natural correspondence and a corresponding modality thereof used for the first-mode notification.

TABLE 1

| Result | Cause | |
|---|---|---|
| (first-mode | (predicted by | |
| notification) | user) | Modality |
| Shadow | Sunlight is | Visual notification |
| | coming inside | (projection of image |
| | | or the like) |
| Sound of rain | It's raining | Auditory |
| | outside | notification |
| | | (reproduction of |
| | | sound or the like) |
| Wind | Window is | Tactile notification |
| | opened | (output of wind or |
| | | the like) |

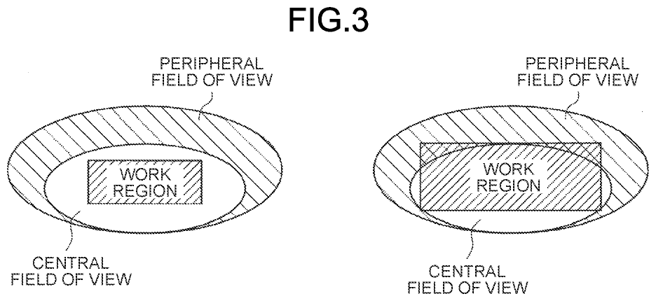

In addition, the data processing unit 150 controls to project the generated first-mode notification within the peripheral field of view. The data processing unit 150 can prevent hindrance of user's work by giving the first-mode notification not to overlap the central field of view and not to overlap the work region. Accordingly, it is possible to implement notification that is not noticed when the user is concentrating on the work or that can easily be disregarded even though the user notices the notification. Here, FIG. 3 is a diagram for explaining the field-of-view range and the work region according to the present embodiment. When the first-mode notification is projected within the peripheral field of view, there is no problem even if the first-mode notification is projected onto any location of the peripheral field of view as long as the work region is within the central field of view as illustrated on the left side of FIG. 3. However, in a case where the work region overlaps the peripheral field of view as illustrated on the right side of FIG. 3, the data processing unit 150 causes the first-mode notification to be displayed while avoiding a portion overlapping the work region in the peripheral field of view, thereby preventing the hindrance of the user's work.

Here, Table 2 below provides an example of an element required for implementing an expression suitable for a space to which the first-mode notification is given without causing an uncomfortable feeling.

TABLE 2

| | |
|---|---|
| Visual | Displayed outside peripheral field of |
| notification | view and work region |
| Auditory | Selecting appropriate volume suitable |
| notification | for situation where fade-in and fade- |
| | out are used |
| Tactile | Selecting intensity of stimulus |
| notification | suitable for situation |
| Olfactory | Selecting smell suitable for |
| notification | situation |

Timings at which the first-mode notification and the second-mode notification are output by the data processing unit 150, etc. will be described in detail in each example to be described later.

In addition, the notification target is not limited to a virtual object (second-mode notification) such as a projection image, and may be a real object. In this case, the first-mode notification serves to casually remind the user of the presence of the real object.

The data processing unit 150 outputs data to be registered to the storage unit 170. For example, the environment recognition result obtained by the environment recognition unit 120, the user identification result obtained by the user recognition unit 140, and the like may be recorded in the storage unit 170.

(Timer 160)

The timer 160 is used at the time of referring to time.

(Storage Unit 170)

The storage unit 170 is implemented by a read only memory (ROM) storing programs, operation parameters, and the like used for the recognition of the environment recognition unit 120, the detection of the field-of-view detection unit 130, the recognition of the user recognition unit 140, and the processing of the data processing unit 150, and a random access memory (RAM) temporarily storing parameters that change appropriately and the like.

The configuration of the information processing device 100 according to the present embodiment has been described in detail above. Note that the environment recognition unit 120, the field-of-view detection unit 130, the user recognition unit 140, and the data processing unit 150 can function by means of a control unit that is not illustrated. The control unit included in the information processing device 100 has a hardware configuration. The control unit functions as an arithmetic processor and a controller, and controls overall operation according to various programs in the information processing device 100. The control unit is implemented by, for example, an electronic circuit such as a central processing unit (CPU) or a microprocessor. In addition, the control unit may include a read only memory (ROM) storing programs, operation parameters, and the like to be used, and a random access memory (RAM) temporarily storing parameters that change appropriately and the like.

In addition, the configuration of the information processing device 100 is not limited to the example illustrated in FIG. 2. For example, at least a part of the configuration of the information processing device 100 may be implemented by an external device such as a server.

Furthermore, the information processing device 100 may be implemented by a smart home terminal, a PC, a smartphone, a tablet terminal, an HMD, a home server, an edge server, an intermediate server, a cloud server, or the like.

<2-2. Example of Configuration of Sensor Device 200>

The sensor device 200 includes various kinds of sensors sensing a real space, and examples thereof may include a human sensor 210, an acceleration sensor 220, a depth sensor 230, a microphone 240, a camera 250, a gyro sensor 260, a geomagnetic sensor 270, and the like. Additionally, the sensor device 200 may also include, for example, an optical sensor, an illuminance sensor, a force sensor, an ultrasonic sensor, an atmospheric pressure sensor, a gas sensor (Co2), a thermal camera (far-infrared camera), or the like. The sensor device 200 may include a plurality of sensors, and the plurality of sensors may be each provided in the space. Furthermore, as illustrated in FIG. 1, the sensor device 200 may be provided in the drive projector.

<2-3. Example of Configuration of Output Device 300>

The output device 300 functions to output information to the real space, and examples thereof may include a projector 310, a speaker 320, a vibration unit 330, a wind output unit 340, a smell output unit 350, and the like. Additionally, the output device 300 may also include, for example, a display, a head mounted display (HMD), an air conditioner, or the like. The output device 300 may include a plurality of output devices, and the plurality of output devices may be each provided in the space. The output device 300 (drive projector) including a projector 310 as an example is illustrated in FIG. 1.

In addition, the drive projector may be equipped with an ultrasonic speaker having high directivity as an example of the speaker 320. In a case where the notification is given by outputting a voice (auditory notification), the notification can be given only to a target user.

Furthermore, the information processing device 100 can grasp in advance the positions (three-dimensional positions in the space) of the sensor device 200 and the output device 300.

### 3. EXAMPLES

Next, the information processing system according to the present embodiment will be described in detail using a plurality of examples.

<3-1. First Example>

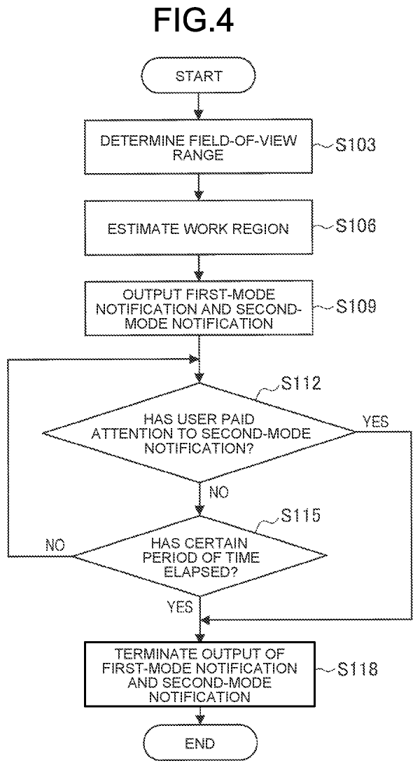

FIG. 4 is a flowchart illustrating an example of a flow of operation processing according to a first example of the present embodiment. As illustrated in FIG. 4, first, the field-of-view detection unit 130 of the information processing device 100 determines a field-of-view range of the user (a central field-of-view region and a peripheral field of view) (Step S103).

Subsequently, the work region estimation unit 151 estimates a work region of the user (Step S106).

Subsequently, the data processing unit 150 controls a first-mode notification and a second-mode notification to be output from the output device 300 (Step S109). The first-mode notification is output to the peripheral field of view of the user (other than the work region), and the second-mode notification is output to a location that is around the user but outside the peripheral field of view of the user and away from the first-mode notification (preferably a location that falls within the field-of-view range of the user if a user's face is turned toward the location).

Subsequently, the data processing unit 150 determines whether or not the user has paid attention to the second-mode notification (Step S112). For example, the data processing unit 150 determines whether or not a user's line of sight has faced the second-mode notification, the user's line of sight being detected from a face orientation, a posture, or the like of the user on the basis of a captured image. The attention to the second-mode notification is assumed to be a case where the user notices the first-mode notification and is interested in the first-mode notification, predicts a cause of the first-mode notification from an expression thereof, and turns his/her line of sight toward the second-mode notification, or a case where the user unconsciously turns his/her line of sight toward the second-mode notification.

Subsequently, when a certain period of time has elapsed in a state where the user does not pay attention to the second-mode notification (Step S112/No and Step S115/Yes), the data processing unit 150 terminates the output of the first-mode notification and the second-mode notification (Step S118). The case where a certain period of time has elapsed in a state where the user does not pay attention to the second-mode notification can be a case where the user is concentrating on work and fails to notice the first-mode notification, a case where the user has noticed the first-mode notification but disregards the first-mode notification because the user wants to continue the work, or the like. In either case, the output of the first-mode notification and the second-mode notification can be terminated without forcing the user who is working to change his/her gaze target, thereby preventing the user from feeling annoyed.

<3-2. Second Example>

Next, a second example will be described. In the second example, the notification target is a real object.

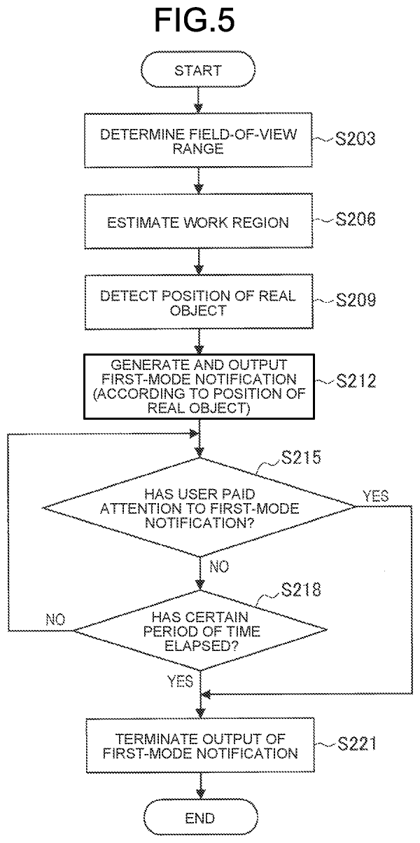

FIG. 5 is a flowchart illustrating an example of a flow of operation processing according to a second example of the present embodiment. As illustrated in FIG. 5, first, the field-of-view detection unit 130 of the information processing device 100 determines a field-of-view range of the user (a central field-of-view region and a peripheral field of view) (Step S203).

Subsequently, the work region estimation unit 151 estimates a work region of the user (Step S206).

Subsequently, the data processing unit 150 detects a position of the real object, which is a notification target (Step S209). Note that in a case where the position of the real object is already known and recorded, for example, in the storage unit 170, the data processing unit 150 acquires position information from the storage unit 170.

Next, the data processing unit 150 generates and outputs a first-mode notification according to the position of the real object (Step S212). For example, in a case where there is a notification regarding an actual window, door, kitchen, television, washing machine, or the like, the data processing unit 150 generates and outputs a first-mode notification expressing that wind is blowing, a sound is being generated, vibration is being generated, a shadow is being cast, or light is coming inside from the position thereof. For example, in a case where it is detected that a key of the door is not locked, a sound of the door being opened, light coming inside from the door, or the like is output, thereby making it possible to guide user's line of sight and consciousness to the door (recalling the door).

Note that the data processing unit 150 may generate the first-mode notification simply reminding the user in a casual manner of the presence of the real object without using the position of the real object. For example, in a case where it has begun to rain and it is desired to recommend the user to take laundry inside, a sound of rain, a sound of wind, a sound of clothespins colliding with each other, or the like can be reproduced at a small volume, thereby recalling that it has begun to rain and it is needed to take the laundry inside.

Subsequently, the data processing unit 150 determines whether or not the user has paid attention to the first-mode notification (Step S215). In the present example, the first-mode notification is a notification for guiding user's line of sight and consciousness to the real object.

Subsequently, when a certain period of time has elapsed in a state where the user does not pay attention to the first-mode notification (Step S215/No and Step S218/Yes), the data processing unit 150 terminates the output of the first-mode notification (Step S221). The case where a certain period of time has elapsed in a state where the user does not pay attention to the first-mode notification can be a case where the user is concentrating on work and fails to notice the first-mode notification, a case where the user has noticed the first-mode notification but disregards the first-mode notification because the user wants to continue the work, or the like. In either case, the output of the first-mode notification can be terminated without forcing the user who is working to change his/her gaze target, thereby preventing the user from feeling annoyed.

<3-3. Third Example>

Next, a third example will be described. Here, it will be described that timings at which a first-mode notification and a second-mode notification are output are adjusted.

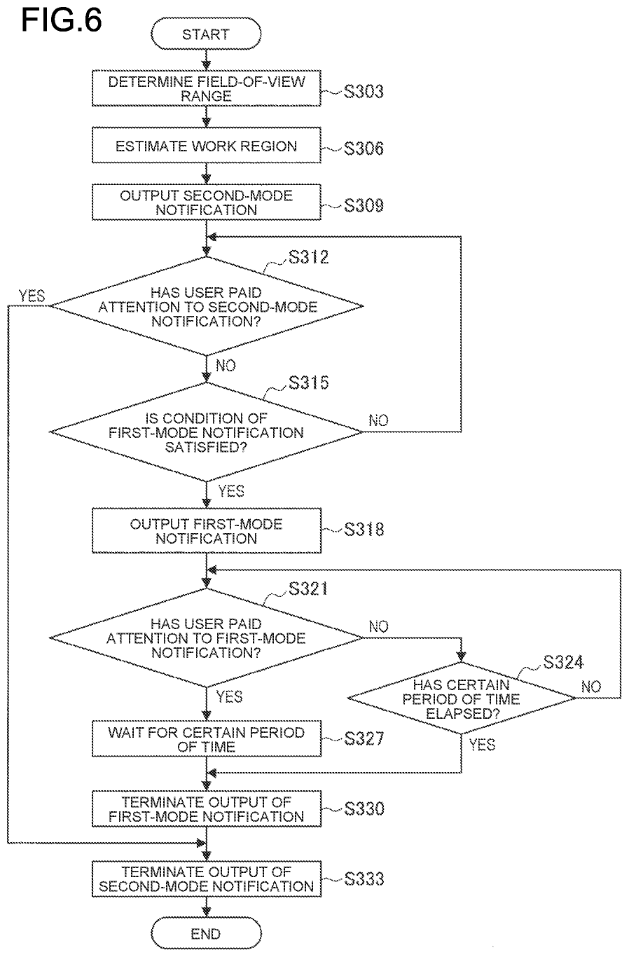

FIG. 6 is a flowchart illustrating an example of a flow of operation processing according to a third example of the present embodiment. As illustrated in FIG. 6, first, the field-of-view detection unit 130 of the information processing device 100 determines a field-of-view range of the user (a central field-of-view region and a peripheral field of view) (Step S303).

Subsequently, the work region estimation unit 151 estimates a work region of the user (Step S306).

Subsequently, the data processing unit 150 outputs a second-mode notification (Step S309).

Subsequently, the data processing unit 150 determines whether or not the user has paid attention to the second-mode notification (Step S312).

Subsequently, in a case where the user does not pay attention to the second-mode notification (Step S312/No), the data processing unit 150 determines whether or not a condition of a first-mode notification is satisfied (Step S315). The condition of the first-mode notification is assumed to be, for example, a case where a deadline for a task is approaching (for example, one hour before going out, an alarm for a task registered by the user, or the like), a case where a certain period of time has elapsed since the second-mode notification was output, or the like.

Subsequently, in a case where the condition of the first-mode notification is satisfied (Step S315/Yes), the data processing unit 150 outputs the first-mode notification (Step S318).

Subsequently, in a case where the user has paid attention to the first-mode notification (Step S321), the data processing unit 150 waits for a certain period of time (Step S327). Accordingly, the second-mode notification is prevented from being deleted before the user shifts his/her line of sight to the second-mode notification.

Then, after waiting for the certain period of time or in a case where the certain period of time has elapsed in a state where the user does not pay attention to the first-mode notification (Step S321/No and Step S324/Yes), the data processing unit 150 terminates the output of the first-mode notification (Step S330), and subsequently terminates the output of the second-mode notification (Step S333). The output of the first-mode notification and the output of the second-mode notification may be sequentially terminated, or may be terminated at the same time.

Note that, in a case where the user has paid attention to the second-mode notification before the condition of the first-mode notification is satisfied (Step S312/Yes), the data processing unit 150 terminates the output of the second-mode notification (Step S333).

### 4. SUPPLEMENT

In the present system, different modalities may be used for the first-mode notification and the second-mode notification.

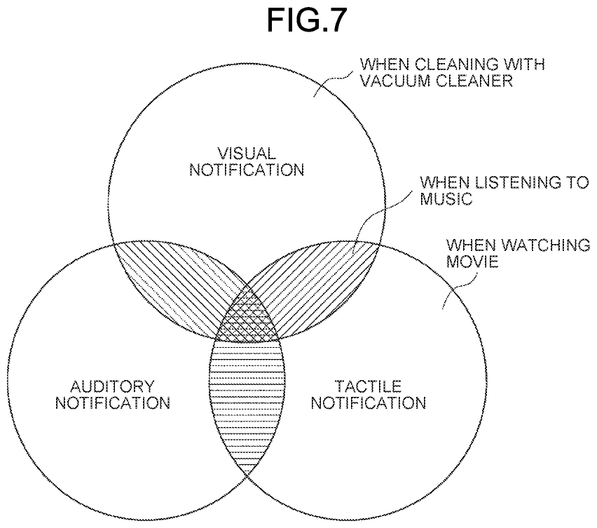

Furthermore, a modality may be selected or modalities may be combined according to a user's situation. FIG. 7 is a diagram for explaining a combination of modalities according to a situation for use in the first-mode notification and second-mode notification according to the present embodiment. As illustrated in FIG. 7, for example, in a case where there are a visual notification, an auditory notification, and a tactile notification, when the user is listening to music, since presentation of visual information is not appropriate, presentation of auditory information and/or presentation of tactile information is selected. In addition, when the user is watching a movie, since presentation of visual information and presentation of auditory information are not appropriate, presentation of tactile information (for example, vibration, wind, or the like) is selected. In addition, when the user is cleaning with a vacuum cleaner, presentation of auditory information is not appropriate because of noise, and presentation of tactile information is also not appropriate because vibration is transmitted from the vacuum cleaner itself. Thus, presentation of visual information is selected. Note that, although FIG. 7 provides three types of presentation, an olfactory notification may be added if necessary.

In addition, in a case where the work region is not within the peripheral field of view, since presentation of visual information is not appropriate, the data processing unit 150 preferably uses another modality such as presentation of auditory information or presentation of tactile information.

In addition, in a case where a plurality of users are targeted, the first-mode notification may be output to a location where respective peripheral fields of view of the users overlap each other. In addition, in a case where there are a plurality of users in the space, when it is desired to notify only a specific user, the first-mode notification may be first given within a peripheral field of view of the specific user, and the second-mode notification may be output when only the specific user turns his/her line of sight in a predetermined direction (for example, when looking back).

Furthermore, a transmissive HMD worn by the user on a daily basis may be applied as the output device 300, such that a virtual wall is displayed (AR display), and a second-mode notification (a virtual window) is output thereto.

In addition, in the present system, unlike the conventional notification, a notification having a low degree of urgency but having a high degree of importance is more effective. For example, on a day with good weather and low humidity, “drying futons” may be suggested by combining a visual modality by a window and a tactile modality by wind. In addition, in cooperation with an existing scheduler, the present system may urge departure from 1 hour to 30 minutes before the departure time, and the notification may switch to an interrupt notification, which is a conventional alarm, from 30 minutes before the departure time. Accordingly, the notification can be reliably performed while reducing user's stress.

In addition, if a task is input in advance, implementation of the task can be casually urged. For example, “dishwashing” may be input, and a notification may be given by the present system through a sound of water and a sound of dishes “clattering” by the automatic starting with the timer (for example, after 1 hour, after 2 hours, or the like).

Furthermore, in a case where there are a plurality of users, the first-mode expression can be displayed, for example, at a position visible only to a standing person, thereby urging the standing person to “do housework while standing”.

### 5. CONCLUSION

As described above, in the information processing system according to the embodiment of the present disclosure, it is possible to casually notify at least the user that there is a certain notification without disturbing the user's work.

The preferred embodiment of the present disclosure has been described in detail above with reference to the accompanying drawings, but the present technology is not limited to such examples. It is obvious that a person having ordinary knowledge in the technical field of the present disclosure can conceive various alterations or modifications within the scope of the technical idea set forth in the claims, and it is of course to be understood that the alterations or modifications also fall within the technical scope of the present disclosure.

For example, computer programs can be created in hardware such as a CPU, a ROM, and a RAM built in the information processing device 100, the sensor device 200, or the output device 300 described above, so that the information processing device 100, the sensor device 200, or the output device 300 can exhibit its functions. Further, a computer-readable storage medium storing the computer programs is also provided.

In addition, the effects described in the present specification are merely illustrative or exemplary, and are not restrictive. That is, together with the above-described effects or instead of the above-described effects, the technology according to the present disclosure can accomplish other effects apparent to those skilled in the art from the description of the present specification.

Note that the present technology can also have the following configurations.

(1)

An information processing device comprising a control unit that controls to output, within a peripheral field-of-view region of a user, a first-mode notification for guiding the user to a notification target disposed in a real space on the basis of determination information on a field-of-view range of the user based on a captured image.

(2)

The information processing device according to (1), wherein

the determination information on the field-of-view range is a field-of-view range and a work region of the user in the real space, and

the control unit

controls to output the first-mode notification within the peripheral field-of-view region excluding the work region of the user.

(3)

The information processing device according to (1) or (2), wherein the peripheral field of view is a region excluding a central field-of-view region in the field-of-view range of the user.

(4)

The information processing device according to any one of (1) to (3), wherein the first-mode notification is an image showing a shadow of the notification target.

(5)

The information processing device according to any one of (1) to (4), wherein

the notification target is a second-mode notification showing notification contents, and

the control unit controls to output the second-mode notification outside the field-of-view range of the user.

(6)

The information processing device according to (5), wherein the control unit

outputs the first-mode notification and the second-mode notification, and controls to terminate the output of the first-mode notification and the second-mode notification when the user has paid attention to the second-mode notification or a certain period of time has elapsed since the first-mode notification and the second-mode notification are output.

(7)

The information processing device according to (5), wherein the control unit

outputs the first-mode notification after outputting the second-mode notification, and controls to terminate the output of the first-mode notification when the user has paid attention to the first-mode notification or a certain period of time has elapsed since the first-mode notification is output.

(8)

The information processing device according to any one of (1) to (4), wherein

the notification target is a real object, and

the first-mode notification is notification information recalling presence of the real object.

(9)

The information processing device according to (8), wherein the control unit outputs the first-mode notification for causing attention of the user to be directed toward the real object.

(10)

The information processing device according to any one of (1) to (8), wherein the control unit controls the first-mode notification to be given at least by auditory presentation, tactile presentation, or olfactory presentation according to a situation of the user.

(11)

An information processing method comprising

controlling, by a processor, to output, within a peripheral field-of-view region of a user, a first-mode notification for guiding the user to a notification target disposed in a real space on the basis of determination information on a field-of-view range of the user based on a captured image.

(12)

A program for causing a computer to function as

a control unit that controls to output, within a peripheral field-of-view region of a user, a first-mode notification for guiding the user to a notification target disposed in a real space on the basis of determination information on a field-of-view range of the user based on a captured image.

### REFERENCE SIGNS LIST

1 INFORMATION PROCESSING SYSTEM
40 FIRST-MODE NOTIFICATION
50 SECOND-MODE NOTIFICATION
60 PERIPHERAL FIELD-OF-VIEW REGION
62 CENTRAL FIELD-OF-VIEW REGION
100 INFORMATION PROCESSING DEVICE
110 I/F UNIT
120 ENVIRONMENT RECOGNITION UNIT
130 FIELD-OF-VIEW DETECTION UNIT
140 USER RECOGNITION UNIT
150 DATA PROCESSING UNIT
151 WORK REGION ESTIMATION UNIT
152 OUTPUT GENERATION UNIT
160 TIMER
170 STORAGE UNIT
200 SENSOR DEVICE
210 HUMAN SENSOR
220 ACCELERATION SENSOR
230 DEPTH SENSOR
240 MICROPHONE
250 CAMERA
260 GYRO SENSOR
270 GEOMAGNETIC SENSOR
300 OUTPUT DEVICE
310 PROJECTOR
320 SPEAKER
330 VIBRATION UNIT
340 WIND OUTPUT UNIT
350 SMELL OUTPUT UNIT

1. An information processing device comprising a control unit that controls to output, within a peripheral field-of-view region of a user, a first-mode notification for guiding the user to a notification target disposed in a real space on the basis of determination information on a field-of-view range of the user based on a captured image.

2. The information processing device according to claim 1, wherein
the determination information on the field-of-view range is a field-of-view range and a work region of the user in the real space, and
the control unit
controls to output the first-mode notification within the peripheral field-of-view region excluding the work region of the user.

3. The information processing device according to claim 1, wherein the peripheral field of view is a region excluding a central field-of-view region in the field-of-view range of the user.

4. The information processing device according to claim 1, wherein the first-mode notification is an image showing a shadow of the notification target.

5. The information processing device according to claim 1, wherein
the notification target is a second-mode notification showing notification contents, and
the control unit controls to output the second-mode notification outside the field-of-view range of the user.

6. The information processing device according to claim 5, wherein the control unit
outputs the first-mode notification and the second-mode notification, and controls to terminate the output of the first-mode notification and the second-mode notification when the user has paid attention to the second-mode notification or a certain period of time has elapsed since the first-mode notification and the second-mode notification are output.

7. The information processing device according to claim 5, wherein the control unit
outputs the first-mode notification after outputting the second-mode notification, and controls to terminate the output of the first-mode notification when the user has paid attention to the first-mode notification or a certain period of time has elapsed since the first-mode notification is output.

8. The information processing device according to claim 1, wherein
the notification target is a real object, and
the first-mode notification is notification information recalling presence of the real object.

9. The information processing device according to claim 8, wherein the control unit outputs the first-mode notification for causing attention of the user to be directed toward the real object.

10. The information processing device according to claim 1, wherein the control unit controls the first-mode notification to be given at least by auditory presentation, tactile presentation, or olfactory presentation according to a situation of the user.

11. An information processing method comprising
controlling, by a processor, to output, within a peripheral field-of-view region of a user, a first-mode notification for guiding the user to a notification target disposed in a real space on the basis of determination information on a field-of-view range of the user based on a captured image.

12. A program for causing a computer to function as
a control unit that controls to output, within a peripheral field-of-view region of a user, a first-mode notification for guiding the user to a notification target disposed in a real space on the basis of determination information on a field-of-view range of the user based on a captured image.
